(19) United States
(12) Patent Application Publication
(10) Pub. No.: US 2004/0158990 A1
(43) Pub. Date: Aug. 19, 2004

(54) Safety razor

(76) Inventor: Heike van der Heide, Berlin (DE)

Correspondence Address: Law Offices of Karl Hormann, P.O. Box 381516, Cambridge, MA, 02238-1516, US

(21) Appl. No.: 10/779,119

(22) Filed: Feb. 16, 2004

Related U.S. Application Data
(63) Continuation-in-part of application No. 10/161,525, filed on Jun. 3, 2002.

(30) Foreign Application Priority Data
Mar. 8, 2002 (DE) GM 300 03 800.9
Jan. 23, 2004 (DE) 20 2004 001 085.2

(51) Int. Cl. B26B 19/00

(52) U.S. Cl. 30/34.1; 30/50

(57) ABSTRACT

A safety razor provided with an elongate handle and first and second blade supports at opposite ends of the handle, one of the blade supports being substantially smaller than the other blade support to allows shaving patterns of small contours into a beard. In one embodiment, one of the blade supports is provided with a slide mechanism for moving relative to the handle between idle and operative positions.

### REFERENCE TO RELATED APPLICATION

This is a continuation-in-part of application Ser. No. 10/161,525 filed 3 Jun. 2002.

### BACKGROUND OF THE INVENTION

1. Field of the Invention

The invention, in general, relates to a safety razor of the kind provided with razor blades and, more particularly to a safety razor suitable for producing shaved patterns or contours of small surface area.

2. The State of the Prior Art

Many different safety razors are known with an approximately rectangular, oval or circular external configuration of the blade head. In most cases, these known safety razors are provided with one of more blades disposed in parallel with respect to each other in a rigid or hinge-mounted blade head with an appropriate skin engagement surface. Blade structures of annular cutting edge formations disposed in various usually round or oval blade mounting heads are known as well.

For instance, U.S. Pat. Nos. 2,614,321; 3,465,436 and 3,702,026 as well as European Patent EP 0,759,836 describe razors with round or oval blade mounting heads. WO 02/07935 A1 discloses a wet razor the blade mounting head of which is provided with a skin engaging surface of approximately rectangular configuration with strongly rounded corners. A special shaving head for razors is described in German patent specification DE 44 05 576 C2. Its skin engaging surface, seen in the shaving direction, is concavely bulged such that during shaving the skin in the area of the concave skin engagement surface is convexly curved.

U.S. Pat. No. 4,285,124 discloses a safety razor for trimming beards. It is provided with at least one rigidly mounted shaving head with a blade and, furthermore, with a retractable miniature shaving head and blade. The miniature shaving head is longitudinally moveable between two members forming a handle. In a first position, the miniature razor head is retracted behind a stationary razor head and, in a second position, it is disposed in front of the razor head. The drawback of this arrangement is that during use of the miniature head the razor head is not sufficiently far removed and is in fact interfering with the operation of the miniature head. Moreover, the guide constituted by the handle is in adequate while it is not possible so to structure the members as would be necessary to provide a functionally safe razor.

U.S. Pat. No. 4,461,078 discloses another razor provided with first and send handles. At one end, the two handles are connected by a hinge; at its other ends each handle is supporting a razor head. The two razor heads are of different sizes. When in use and unfolded, the handles form an elongate haft at each end of which there is provided a razor head. Its disadvantage is that in use, the two handles may deviate from their extended disposition so that the non-used razor head may cause injuries. Also, the miniature razor head is unprotected and is thus subject to damage.

The disadvantage of the razors disclosed by the latter two U.S. patents is that they do not provide a secure grip and may thus render shaving rather difficult and, possibly, hazardous.

The disadvantage of all known safety or wet razor devices is that the dimensions of their skin engaging surfaces, relative to desired beard contours, are rather too large. Moreover, they suffer from the drawback that as a rule their direct cutting surfaces are of rectangular configuration with a wide margin between blades and outer contour of the blade head. Another significant disadvantage of those razors is that special contours in a beard necessitate the use of another razor.

### OBJECTS OF THE INVENTION

An object of the invention is to eliminate the difficulty encountered by a bearded person seeking to shave defined and, more particularly, small contours into or out of the surface of his beard in consequence of the unavailability of suitable safety razors. With conventional safety razors, such contours can only be cut at the risk of cuts, particularly in the area of the lower lip.

A further object is to provide a razor with an additional miniature razor head the construction of which would satisfy the functional requirements necessary to provide a safe grip and stability for safe handling, i.e. a safe grip and stability.

Yet another object is to provide a miniature razor head which can be exposed in a simple and convenient manner only when it is needed, but which is sheltered or hidden by the components of the razor when not in use.

Furthermore, It is an object of the invention to provide a razor having two razor heads which do not interfere with each other when in use in a way which may cause injury.

### BRIEF SUMMARY OF THE INVENTION

In accordance with the invention, a safety razor is being proposed combining a conventional safety razor at one end of its handle with a small or miniaturized razor of a diameter in the order of the handle disposed at its opposite end. The miniaturized razor disposed at the opposite end of the handle is provided with a small blade unit with a skin engaging surface which is smaller than the skin engaging surface of the conventional blade head at the other end of the handle. The geometric configuration of the small blade unit of the safety razor in accordance with the invention is different from the blade head at the other end of the handle of safety razor. The blade units are configured to conform to individually desired beard contours and are provided with a round, oval or polygonal skin engaging surface. One or more blades may be arranged in the blade unit. They may be provided with wedge-shaped cutting edges at one side or both sides. The blades are supported in a frame in a conventional manner and, depending upon their shape and size of the blade unit, they are centered on a point of support.

In a particular embodiment the skin engaging surface and the blades of the blade unit are convexly bulging in the direction of a surface to be shaved. The blade unit may be fixedly or removably mounted on the handle. Alternatively, the blade unit may be mounted on the handle by a hinge. In order to conform to individual desires in respect of a beard contour and to shave even very small contours, the blade unit is of a diameter substantially corresponding to the diameter of the handle. In accordance with a further embodiment, the blade unit is covered by a protective hood snap-fitted to the handle by a grooved edge.

In yet another embodiment, the objects are accomplished by a razor having first and second supports provided at one end with means for connecting a razor head and provided at their other ends with a slide moveably mounted in a guide and provided with fasteners for supporting a miniature razor head for longitudinal movement. The supports are provided with grip shells. Preferably, the supports engage each other in a surface-abutting relationship and are structured for receiving a guide. In an advantageous embodiment, the supports and the grip shells are provided with recesses for receiving a miniature razor head. Preferably, the supports and slide are provided with latching means. The razor head and the miniature razor head are disposed at an angle relative to the supports such that they face in opposite directions. Advantageously, the slide is provided with a handle and the grip shells are removably mounted on the supports.

The advantage of this arrangement is that grip shells may be attached on the supports regardless of the slide and the miniature razor head formed thereon. The shells may thus be given an ergonomically and esthetically conditioned shape. The slide is securely retained between the supports and carries the miniature razor head on relatively short and, hence, securely positioned fasteners. On the one hand, the miniature razor head may be sufficiently moved outwardly for a perfect shave, and on the other hand, it may be completely hidden within the supports and the grip shells. When the miniature razor head is being used, the razor head is directed away from the body thus rendering injuries impossible. The structure is such that its few components may be assembled easily.

### DESCRIPTION OF THE SEVERAL DRAWINGS

The novel features which are considered to be characteristic of the invention are set forth with particularity in the appended claims. The invention itself, however, in respect of its structure, construction and lay-out as well as manufacturing techniques, together with other objects and advantages thereof, will be best understood from the following description of preferred embodiments when read in connection with the appended drawings, in which:

FIG. 1 depicts a beard with contoured lines;

FIG. 2 is a sectional view of the lower portion of a handle of a safety razor;

FIGS. 3-9 are schematic representations of blade units for contour shavings;

FIG. 10 is an exploded view of the lower portion of the handle of a safety razor and a protective cover; and

FIG. 11 depicts a conventional safety razor with a small blade unit in accordance with the invention.

FIG. 12 depicts two views of a further embodiment of the razor in accordance with the invention with retracted miniature razor head;

FIG. 13 depicts the razor with one of its grip shells separated;

FIG. 14 shows a detail of the razor of FIG. 13;

FIG. 15 depicts the razor with one of its grip shells separated and showing the extended miniature razor head;

FIG. 16 is a detailed view of the extended razor head; and

FIG. 17 is a detailed view of the slide arrangement.

### DETAILED DESCRIPTION OF THE PREFERRED EMBODIMENT

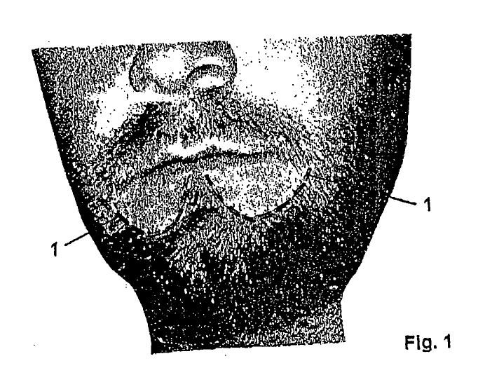

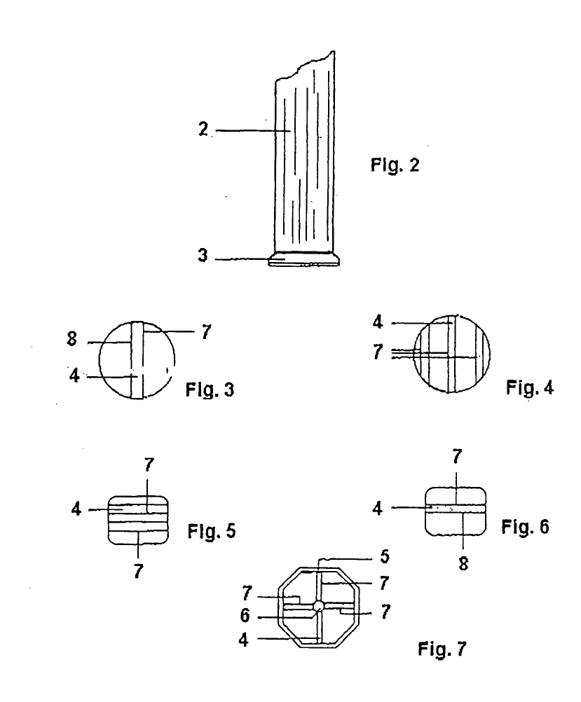

FIG. 1 depicts the lower facial section of a man who likes to have his beard shaved in fancy individually determined contours. The desired ideal contour is indicated by a contour line 1. With conventional safety razors, such contours may either be shaved only with great difficulty or, more likely, not at all, and in the event not without great risk of cuts, particularly in the area of the lower lip.

In order to avoid the necessity of several different safety razors, the invention proposes to arrange an additional blade unit 3 at the other end of a handle 2 of a conventional safety razor. The blade unit 3 is dimensionally structured such that it either substantially corresponds to the diameter of the handle 2 or, depending on special configurations of the handle 2, has a diameter which is approximately identical to that of the handle 2. This blade unit thus ensures that even the smallest contours, more particularly rounded configurations, may be shaved out of a beard. For cleaning the blade unit 3, shavings and residual lather are simply rinsed off by a water jet from a faucet. In accordance with a particular embodiment of the invention, the blade unit 3 may be unscrewed from the handle 2 for cleaning.

In the case of throw-away razors 2 which are discarded once the blades have become dull, the blade unit 3 will be fixedly connected to the handle 2. Safety razors with a replaceable conventional blade head 12 will be provided, at the opposite end of their handle 2, with a releasable and replaceable blade unit 3.

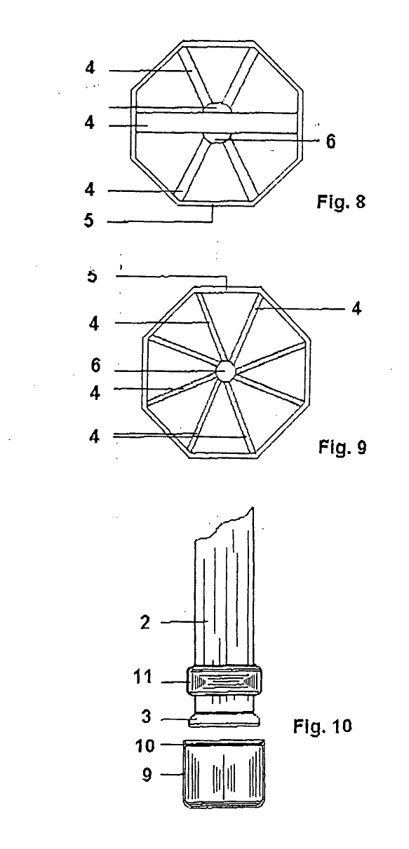

FIGS. 3-9 schematically depict, in top elevation, several different geometric structures of blade units 3 with one or more blades 4. Depending upon the geometric external contour of the handle 2, the blade units 3 may be selected to be of circular, elliptical or polygonal configuration. The blades 4 are mounted in a frame 5 which is preferably made of a polymeric material. The blades 4 may either be glued to the frame 5, or they may be injection-molded into it. In a particular embodiment, the blades 4 are fixed to a centrally disposed mounting and support point 6. Such mountings by means of a mounting and support point 6 are of particular use in the case of somewhat larger blade units 3.

As is well known, the blades 4 of the blade unit 3 are provided, for preferably circular shaving motions, with wedge-shaped cutting edges 7 and are structured as single (FIGS. 3 and- 6) or multiple blade (FIGS. 4, 5, 7-9) arrangements. In accordance with the invention, both margins of the blades 4 may be provided with wedge-shaped cutting edges 7, 8 to yield particularly advantageous shaving effect. So-called tandem blades as shown in FIGS. 4 and 5 may be applied. The blades 4 may be straight or curved and arranged as singles, parallel, crossed, in a star-like configuration and/or in different planes.

FIG. 10 depicts a special embodiment of the end of a handle 2 with a blade unit 3 in accordance with the invention and a schematically shown protective cover 9 adapted to be seated on the handle by snap-fitting into grooves or a grooved margin 10 above a bulge 11 in the handle.

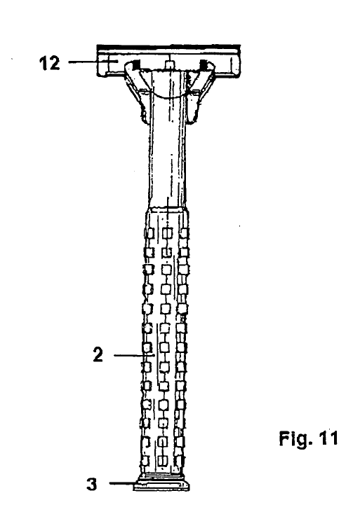

FIG. 11 shows a conventional safety razor with a blade head 12 at the upper end of its handle 2 structured as an inventive combination device provided with a blade unit 3 at the lower end of the handle 2. Following large surface shaving with the blades in blade head 2, the user may use the blade unit 3 to shave individualized contours in his beard (FIG. 1) by rotary shaving motion of the blade unit 3.

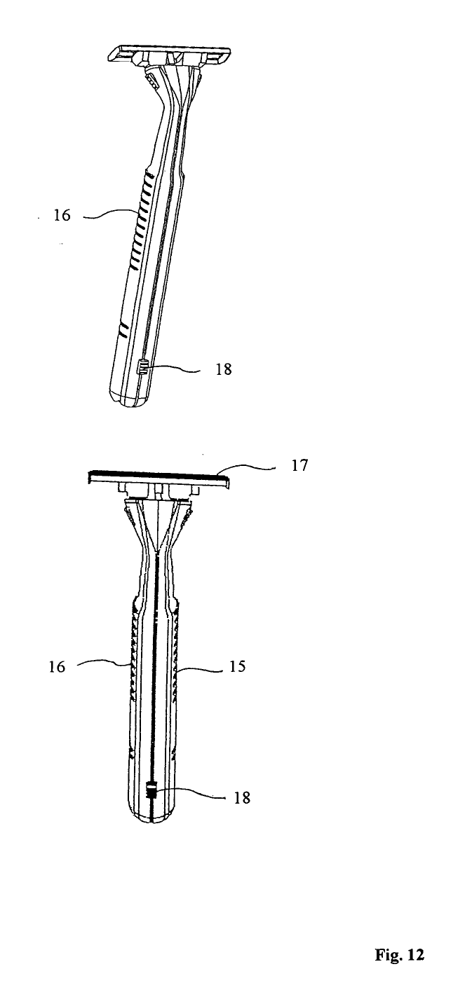

FIG. 12 shows a razor provided with first and second supports 13, 14 and two grip shells 15, 16. It also depicts a replaceable razor head 17 and an actuator 18 of a slide 19 (FIG. 14).

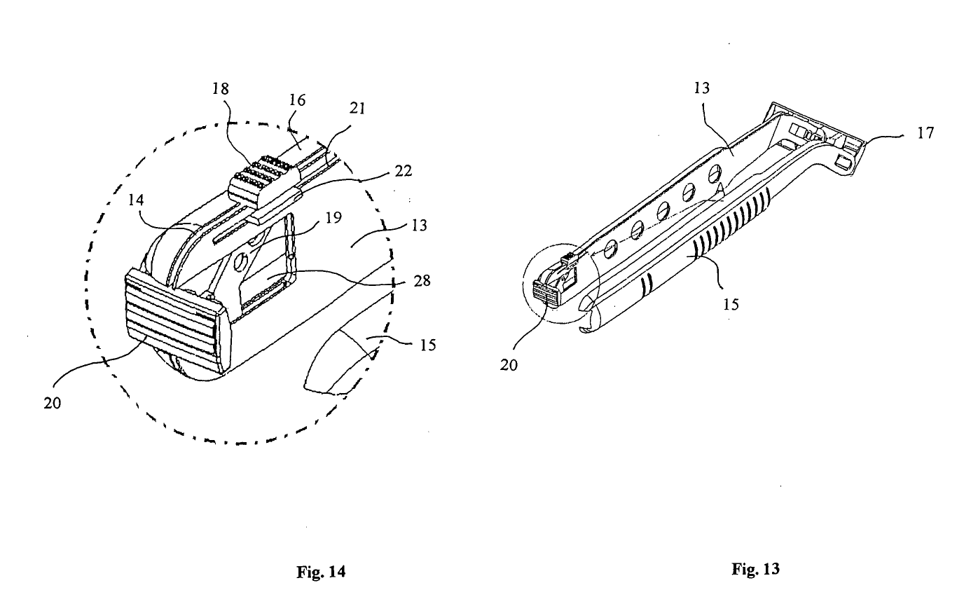

FIG. 13 and FIG. 14 show the same razor with one of its grip shells 15 separated and a detailed view of the supports 13, 14 and of the slide 19 disposed therebetween. As shown, the slide 19 and a miniature razor head 20, which is replaceable as well, are partially retracted into a cavity formed by the grip shells 15, 16. A guide 21 within the supports 13, 14 and correspondingly shaped protrusions 22 on the slide 19 ensure a straight linear movement of the slide 19 and of the miniature razor head 20 within the confines of an opening 28. Within the opening 28, the miniature razor head 20 can be moved to and fro.

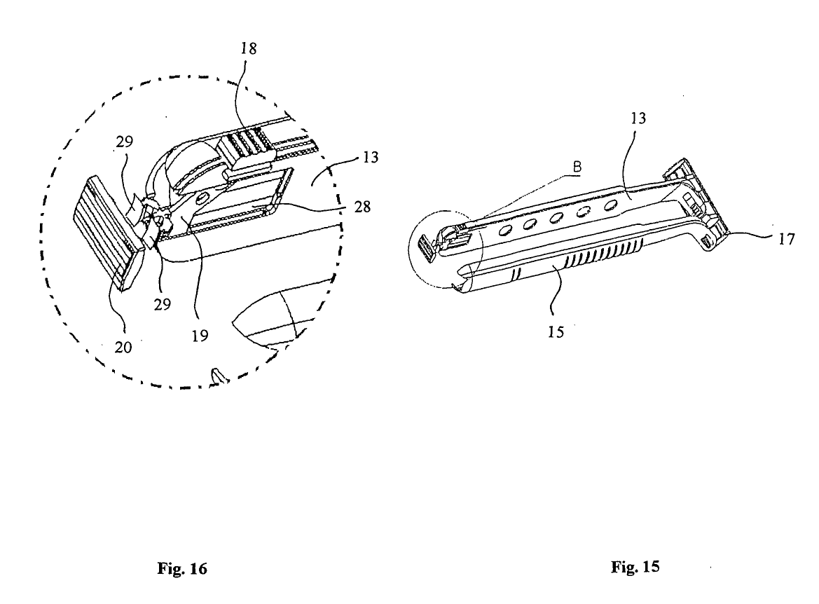

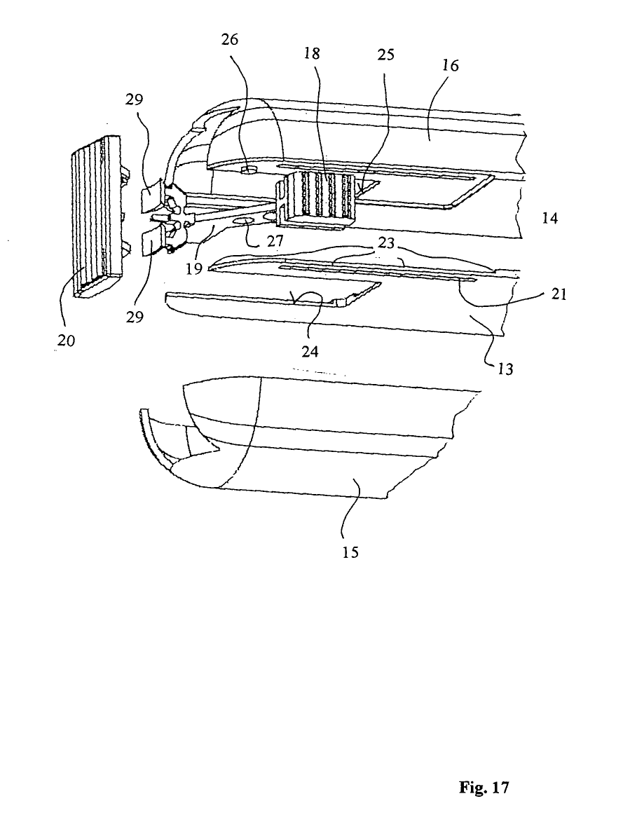

FIG. 15 and FIG. 16 also show the razor with one of its grip shells 15 separated to render visible, in the detailed view of FIG. 16, the supports 13, 14 with a completely extended slide 19 and the miniature razor head 20. By pushing the actuator 18 along the handle formed by the supports 13, 14 and the grip shells 15, 16, the slide 19 may be moved from its retracted position to its shown extended position where it is arrested by locking means 26 (FIG. 17) provided in the supports 13, 14 and slide 19. In this position, the slide 19 extends beyond its guiding and securing supports 13, 14 only by the mounting bracket 29 of the miniature razor head 20. In this manner, the miniature razor head 20 is maintained in a stable position while it is being used. In FIG. 15 the miniature razor head 20 is shown to be separated from its mounting bracket 29 for exchanging its blades or the entire miniature razor head 20.

FIG. 17 offers a detailed view of the two supports 13, 14 and the slide 19 with its actuator 18 moveably disposed between the supports 13, 14. As may be seen, both supports 13, 14 are structured to received the slide 19 thus forming a section of reduced material strength. The supports 13, 14 are provided with recesses 24, 25 which form the opening 28 for receiving the miniature razor head 20 in its retracted position. The slide 21 and the section 23 of reduced thickness are dimensioned such that the slide 19 and the miniature razor head 20 are received completely within the cavity formed by the supports 13, 14 and grip shells 15, 16 and the recesses 24, 25 formed therein. The locking means 26 on the supports 13, 14 extend into openings 27 of the slide 19 to retain the latter in a secure position.

The construction of the razor in-accordance with the invention makes it possible to shape the grip shells 15, 16, regardless of the arrangement of the slide 19, in an ergonomic and esthetic manner. The construction in accordance with the invention also provides for securing the slide 19 within the supports 13, 14 when the miniature razor head 20 is in its operative position and thus makes possible a perfect shave. The miniature razor head 20 can be extended sufficiently far to ensure a perfect shave and may be retracted far enough into the handle to be completely hidden and protected. When one of the two razor heads 17, 20 is being used, the other one faces into a direction away from the body. In this manner, accidental injuries are prevented. By removable mounting the grip shells 15, 16 on the supports 13, 14, the razor may be cleaned in a convenient manner. The few structural components of the razor in accordance with the invention may be assembled in a simple manner either manually or automatically.

Within the ambit of the invention the miniature razor head 20 may be of oval or circular configuration. In other words, by appropriately shaped openings in the grip shells 15, 16 at one end thereof and by a corresponding shape of the recesses 24 25 in the supports 13, 14 it is possible alternatively to utilize rectangular and oval and circular miniature razor heads.

What is claimed is:

1. A safety razor, comprising:
an elongated handle of predetermined diameter;
a first blade support provided with a first skin engaging surface of substantially rectangular cross-section dimensioned to exceed the diameter of the handle and disposed at one end thereof; and
a second blade support provided with a second skin engaging surface of a non-rectangular cross-section smaller than the first skin engaging surface and disposed at the other end of the handle.

2. The safety razor of claim 1, wherein the first blade support is releasably mounted on the handle.

3. The safety razor of claim 1, wherein the first blade support is affixed to the handle.

4. The safety razor of claim 1, wherein the first blade support is adapted to support at least one blade.

5. The safety razor of claim 1, wherein the geometric structure of the second blade support is different from the geometric structure of the first blade support.

6. The safety razor of claim 5, wherein the cross-section of the skin engaging surface of the second blade support is substantially circular.

7. The safety razor of claim 5, wherein the cross-section of the skin engaging surface of the second blade support is substantially oval.

8. The safety razor of claim 5, wherein the cross-section of the skin engaging surface of the second blade support is substantially polygonal.

9. The safety razor of claim 1, wherein each of the first and second blade supports is provided with at least one blade.

10. The safety razor of claim 9, wherein the blade is provided with at least one cutting edge of wedge-shaped configuration.

11. The safety razor of claim 9, wherein the skin engaging surface of the second blade support and the blade are convexly bulging in the direction of a shaving surface.

12. The safety razor of claim 9, wherein the blade is centrally fixed to a support point.

13. The safety razor of claim 1, wherein the second blade support is fixed to the handle.

14. The safety razor of claim 1, wherein the second blade support is releasably mounted on the handle.

15. The safety razor of claim 14, wherein the second blade support is threadedly connected to the handle.

16 The safety razor of claim 1, wherein the second blade support is hingedly connected to the handle.

17. The safety razor of claim 1, wherein the diameter of the second blade support substantially corresponds to the diameter of the handle.

18. The safety razor of claim 1, wherein the second blade support is provided with a protective cover.

19. The safety razor of claim 18, wherein the protective cover is retained on the handle by a snap-fit connection.

20. A safety razor, comprising:
first and second razor heads,
an elongated handle comprising first and second parallel support members mounted in parallel provided at one end with means for mounting one of the first and second razor heads and at an opposite end with means for mounting the other of the first and second razor heads and for slidably moving the other of the first and second razor head between retracted and extended positions relative to the first and second support members; and
means for releasably securing the means for mounting the other of the first and second razor heads in the extended position.

21. The safety razor of claim 20, further comprising grip shells mounted on the exterior of the first and second support members.

22. The safety razor of claim 21, further comprising an actuator protruding from the handle and connected to the slidably means.

23. The safety razor of claim 22, further comprising recesses in the support members and grip shells for receiving the other of the first and second razor heads in its retracted position.

24. The safety razor of claim 23, wherein the releasable securing means comprises at least one opening in the slidably mounting means and a complementary protrusion in one of the support members.

25. The safety razor of claim 24, wherein the first and second razor heads are angularly positioned on the handle to face in opposite directions.
